(19) United States
(12) Patent Application Publication
(10) Pub. No.: US 2020/0180198 A1
(43) Pub. Date: Jun. 11, 2020

(54) METHOD FOR PRODUCING A SEAT FOR A SEATING OF ANY ONE ROAD VEHICLE AND PRODUCT THUS OBTAINED

(71) Applicant: SAPA S.P.A., NAPOLI (NA) (IT)

(72) Inventor: Antonio AFFINITA, NAPOLI (NA) (IT)

(21) Appl. No.: 16/614,433

(22) PCT Filed: May 10, 2018
(86) PCT No.: PCT/IB2018/053243

§ 371 Date: Nov. 18, 2019

(30) Foreign Application Priority Data
May 18, 2017 (IT) 102017000053837

(51) Int. Cl. B29C 45/16; B60N 2/70; B29C 44/08; B29C 44/12; B29C 44/56

(52) U.S. Cl. CPC B29C 45/1618; B60N 2/7017; B29K 2309/08; B29C 44/1271; B29C 44/5681; B29C 44/08

(57) ABSTRACT

Method for producing a seat for a vehicle, the bottom and the foam obtained by molding in a double mold by the following subsequent steps: gluing: in which a robot moves the molded product in front of a glue nozzle; activation: in which the robot transfers the molded product into a heating station, activating the glue; loading: in which a user arranges the cover in a loading station; superimposition: in which the cover is transferred into a superimposition station; simultaneously, a second robot grasps the molded product and moves it into the superimposition station; pressing: in which a plurality of grippers press the edge of the cover against the edge of the bottom, causing irreversible gluing between the bottom and cover, forming the seat; moving-away: in which the second robot grasps the seat from the superimposition station and places it on a conveyor belt to move it away.

### FIELD OF THE ART

The present invention operates in the field of the automobile industry, in particular in the segment adapted for the production of rear seating of vehicles. Still more in detail, the present patent application is dedicated for the production of seats of the rear seating of any one vehicle.

### PRIOR ART

The automobile industry is the branch of the manufacturing industry involved with the design, construction, marketing and sales of engine vehicles. After 2008 and 2009, when this was the industrial sector most hit by the economic and financial crisis, such field once again found momentum, with a growth greater than 25% in 2010. In 2011 nearly 80 million motor vehicles, which include cars and commercial vehicles, were produced throughout the world, making this the number one manufacturing field in the world for turnover. This data suffices to explain the great variety of vehicles present on the market today; vehicles ranging from campers to commercial vans, utility vehicles and sports cars. However, all these vehicles—regardless of the purpose for which they were designed—today pursue the object of lowering pollutant emissions.

Indeed, most of the automobile industry research is now aimed to find solutions in order to respect international agreements and national laws on pollution, which provide for admissible CO₂ percentages that have increasingly lowered over the years. Such lowering of the emissions can be reached in two ways: the first is to optimize the operation of the engines which, at least at present, does not seem to give results sufficient for respecting regulations; the second is to reduce the weight of the vehicle and hence of each component thereof.

Presently, rear seating—also due to the very restrictive car safety laws—is constituted by two separate components: the back and the seat, each of which provided with its own load-bearing structure, a foam filler, a cover fabric of higher or lower quality in accordance with the vehicle model. The load-bearing structure of the seat, also termed “bottom”, is at the present state of the art made of metal.

A first object of the present invention, in order to contribute to reducing vehicle emissions, is to produce the bottom of the rear seating in plastic material, obtaining a weight that is considerably reduced with respect to that produced up to now.

More particularly, the assembly chain that leads to the attainment of the complete seat provides for the coupling between the cover and the bottom and the stretching of the cover on the foam by means of a manual process that causes a useless slowing of the production times. Another consequence of the manual production of the piece is the impossibility of making the seating according to high standards, replicated in an identical manner from one piece to the next.

A second objective of the invention, described in detail hereinbelow, is to optimize the process of producing such components, by automating it.

Even if there are several international patents aimed to lighten the weight of the seating, such as the recent United States patent US 2017 101 188 which incorporates the safety belts group in the seating structure, there do not appear to be any patents which regard the method of assembly thereof, resolving the abovementioned problems.

Due to the present invention, a seating is claimed that is considerably lighter than that currently on the market, and additionally the production process is standardized and automated, obtaining a much quicker and less expensive process.

### DESCRIPTION OF THE INVENTION

According to the present invention, a seat is attained for a seating of any one vehicle, preferably a car. The seating in question is preferably one of the rear seating structures. This is constituted by a bottom adapted to act as a lower structural support of said seat, a filler foam, with a thickness such to render said seat soft and comfortable, and at least one cover layer adapted to enclose and completely finish the upper face of said seat. Said cover can be made of any polymer material such as, merely by way of example, PVC, fabric or leather.

Advantageously, said bottom is made of any one thermoplastic polymer, preferably polypropylene, still more preferably polypropylene with long glass fibers, commonly termed PP LGF.

The use of this material for the bottom not only has the advantage of lightening the weight of this element, without any drop of performance in terms of mechanical and structural strength of the seating, but also allows speeding up the production, since the bottom and the foam are advantageously obtained by means of a molding process by means of a double mold. Said double mold is constituted by a first cell, provided with a male element and a female element, and by at least one second cell, provided with a male element and a female element. Said cells are adapted to assume, in a simultaneous and reversible manner, a first closed configuration in which said male elements and said female elements are partially in contact with each other, by means of the respective contact areas, so as to respectively define a first interspace adapted to be filled with the thermoplastic polymer which will constitute said bottom when cooled and at least one second interspace adapted to contain the previously-described bottom and said foam.

The cells of the multiple mold are also adapted to assume, in a simultaneous and reversible manner, a second open configuration in which said male elements and said female elements are spaced from each other in order to allow the extraction of the solidified finished product. The steps for making the bottom and the foam are the following:
A) injection step: with multiple mold in first closed configuration. By means of a channel placed at said female element of said first cell, advantageously, a predetermined quantity of said thermoplastic polymer at the liquid state—adapted to form said bottom—is injected from a hot chamber to said first interspace of said first cell. In one version of the present invention, due to a suitable configuration of said first cell of said double mold, said bottom advantageously has a plurality of projections which, during the subsequent transfer step, will be provided with a common retention mechanism adapted to be stably and irreversibly engaged with the cover, creating aesthetic recesses on the upper surface of said seat. In such a manner, a “sewn effect” is created which has the advantage of offering a more elaborate image of the achieved element. Advantageously, said retention mechanism can also be and is preferably elastic. Possibly, in said injection step, metal plates for reinforcement or fixing can be co-molded within the bottom;
B) cooling step: one awaits a predetermined time period, starting from the end of said injection step, so as to allow the lowering of the temperature of said thermoplastic polymer constituting said bottom up to its complete solidification;
C) opening and transfer step: with multiple mold in second open configuration, so as to allow the extraction of said bottom from said first cell and then its positioning in said second interspace of said second cell.
   During the transfer, based on the type of seating to be produced, components for various purposes can be advantageously arranged within the mold; these can include a reversibly inflatable air cushion. The latter is advantageously adapted to allow the height-wise adjustment of said seat. Said cushion is positioned within said mold in a first inflated configuration characterized in that it occupies a volume from ½ to about ¼, preferably ⅓ of the overall volume of said foam. Once the mold of the foam is made, said cushion can advantageously and reversibly assume a second deflated configuration, characterized in that it occupies a volume equal to about 1/10 of the volume of said foam. Before foaming, moreover, a tank of a common extinguishing liquid or foam can be arranged within the mold. This characteristic is particularly valid when the seating is situated in proximity to the fuel tanks. As an alternative or in addition to the cushion and the tank, a system of air emission tubes can be advantageously arranged, which is adapted to cool said seat. In this case, said cover will be advantageously micro-perforated in order to allow the outflow of air. Analogous to the system for cooling the seating, also a system of heating elements can be advantageously configured, to be advantageously placed before the foaming step, adapted to allow the controlled heating of the seat.
D) closing and foaming step: with multiple mold in first closed configuration. While a new injection process occurs in said first cell, in said second cell a predetermined quantity of foam is injected so as to fill the interspace present between said bottom and said male element, such that, being solidified, said foam advantageously and irreversibly adheres to the bottom with which it is directly in contact;
E) solidification step: in which one awaits a predetermined time period in order to allow the expansion, the stabilization and the adhesion of said foam to said bottom;
F) extraction step: with multiple mold in second open configuration, in which the finished molded product is extracted from said second cell and, simultaneously, the bottom is extracted from said first cell and placed in said second cell, giving rise to a new transfer step. Advantageously, the molded product thus obtained is characterized in that it is provided with at least one bent perimeter edge belonging to said bottom, whose utility is illustrated in the subsequent processing passages. In one embodiment, if the seat is provided with cushion and/or tank, these can be advantageously inserted within said seat after said step of extracting said molded product from said mold, due to the arrangement of a suitable space obtained on the surface of said bottom. After the insertion of the tank and/or of the cushion, the space is advantageously closed by means of a common closure element welded on said bottom, preferably by means of an ultrasound welding technique.
G) gluing step: in which a first robot provided with a mechanical arm picks up said molded product from said multiple mold and advantageously moves it to a nozzle adapted to spray a predetermined quantity of a common glue coming from a tank connected to said nozzle. In this step, advantageously, a uniform glue layer is spread over the entire surface of said bent perimeter edge of said bottom;
H) activation step: in which said first robot is adapted to transfer said molded product, provided with glue over said bent perimeter edge, into a heating station constituted by a plurality of lamps adapted to increase the temperature of said glue, bringing it to a value comprised between 50° C. and 100° C., preferably 50° C. Such value is advantageously selected for activating the adhesive properties of the glue;
I) loading step: advantageously simultaneous with said activation step and carried out by a user who arranges said cover in a loading station;
(L) superimposition step: in which said loading station advantageously transfers said cover into a superimposition station in which a second robot, it too provided with a mechanical arm, is adapted to position said molded product, picked up from said heating station, on top of said cover and with said foam directed towards said cover;
(M) pressing step: which occurs within said superimposition station, in which a plurality of grippers press the edge of said cover against said bent perimeter edge of said bottom for a time period comprised between 40 sec and 100 sec, preferably 50 sec, causing the irreversible gluing between said bottom and said cover, forming said seat. In one embodiment of the present invention, said superimposition station is advantageously provided with suitable connection means adapted to constrain said cover to said bent perimeter edge of said bottom, not only by means of gluing but also via sewing, ultrasound welding or any other mechanical connection system;
(N) moving-away step: in which said second robot grasps said seat from said superimposition station and places it on a conveyor belt that moves it away from the production area.

The advantages offered by the present invention are evident in light of the description set forth above and will be even clearer due to the enclosed figures and relative detailed description.

### DESCRIPTION OF THE FIGURES

The invention will be described hereinbelow in at least one preferred embodiment as a non-limiting example with the aid of the enclosed figures, in which:

FIG. 1 shows an exploded axonometric view of the components of the seat 10, object of the present patent. The bottom 11, the foam 12 and the cover 13 are seen.

FIG. 2(a) illustrates a schematic section of the seat 10 in which the following can be distinguished: the bottom 11 with the bent perimeter edge 11′ and a projection 14, the foam 12 that fills the internal space of the seat 10, the cover 13 characterized by the recess 16 and kept in contact with the projection 14 of the bottom 11 due to the retention system 15.

FIG. 2(b) shows an alternative version of the seat 10 in which, in addition to the components already illustrated in FIG. 2(a), an air cushion 19 of a tank 20 of extinguishing liquid is placed within the seat 10. In the section of the bottom 11, the hole 17 and the closure element 18 are seen which allow servicing and replacing the cushion 19 or the tank 20 in case of breakage.

FIG. 3 shows an operating scheme for the method, object of the present invention. The processing steps (A-B-C-D-E-F-G-H-I-L-M-N) are listed in the squares while the circles indicate the elements of the plant involved in the reference step.

FIG. 4 shows a plan view scheme of a possible layout of the processing area. The following are visible: the double mold 100, the first robot 60 with the mechanical arm 61, the tank 50 of glue with the spraying nozzle 51, the heating station 70 with the lamps 71-71′-71″, the second robot 75 with the relative mechanical arm 76, the superimposition station 80 with the grippers 81-81′-81″-81′″, the user 91 assigned to work on the loading station 90 and the conveyor belt 95.

FIG. 5 shows a double mold 100 in first closed configuration in which the following are seen: the first cell 101 with the relative male element 101.a and female element 101.b, the interspace 101.d and the contact area 101.c; the second cell 102 with the male element 102.a, the female element 102.b, the interspace 102.d, and the contact area 102.c. Inside, the bottom 11 with the foam 12 is visible.

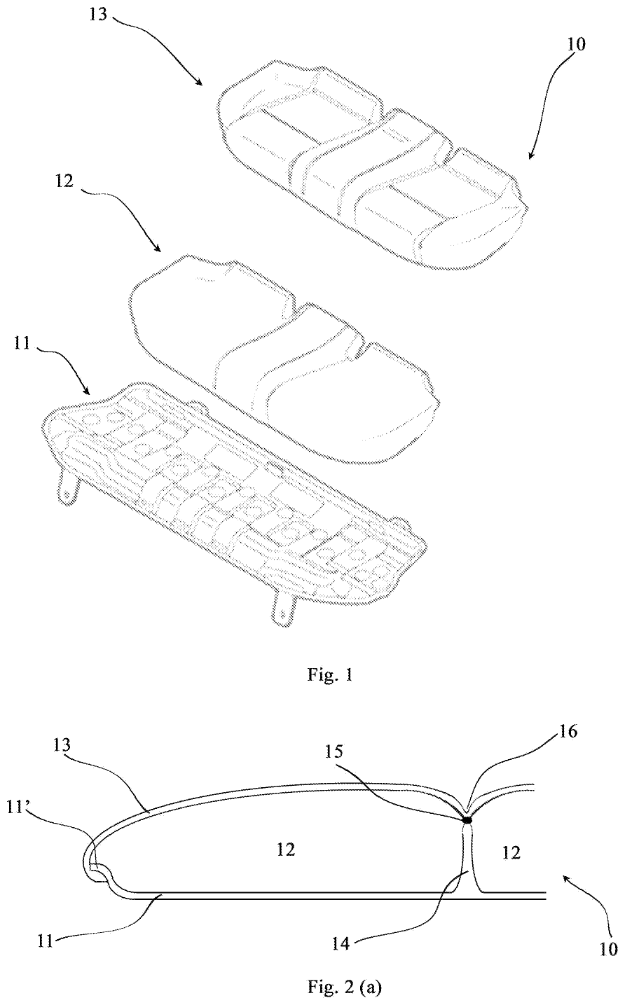

### DETAILED DESCRIPTION OF THE INVENTION

The present invention will now be illustrated in a merely exemplifying manner, neither limiting nor constraining, by making use of the figures which illustrate several embodiments relative to the present inventive concept.

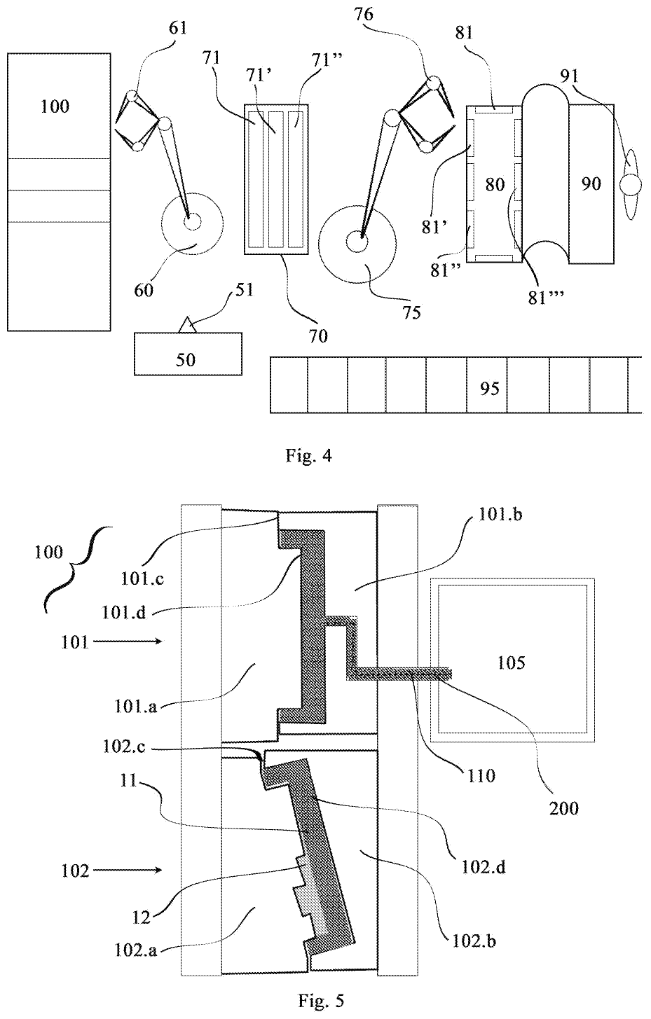

With reference to FIG. 4, one of the possible schemes of the production plant is shown while in FIG. 3, in a flow diagram, the steps for making the seat 10 according to the present invention are listed. In particular, the circles of FIG. 3 indicate the components that participate in the reference step.

In its preferred embodiment, the present invention is adapted to make, in an optimized process, a seat 10 of a rear seating of a car. For a seat 10 with many accessories and finished appearance, this will be constituted by a lower bottom 11, a foam 12 which renders the support surface comfortable and a cover 13 made of leather, fabric or any other material. The finished appearance is given by a design made by aesthetic recesses 16 of the upper cover 13, which give the illusion that the cover 13 is sewn on the seating. Other components which will considerably increase the comfort of the seated user and which constitute manufacturing options for the seat 10 are the following:
a reversibly inflatable air cushion 20 adapted to allow the height-wise adjustment of said seat 10;
a system of air emission tubes which cool said seat 10; in this case the cover 13 will be micro-perforated in order to allow the outflow of air;
a tank 19 of a common extinguishing liquid or foam, above all if the seating is close to a fuel tank;
a system of heating elements adapted to allow the controlled heating of the seat 10.

All these components are arranged within the double mold 100 useful for producing the molded component constituted by the bottom 11 and by the foam 12.

One of the revolutionary aspects of the present invention in fact lies in the fact that the bottom 11, up to now made of metal, is made by means of molding of any one thermoplastic polymer, preferably of polypropylene with long glass fibers, commonly termed PP LGF. Therefore, the production process starts with the first 6 steps that are typical for the double mold 100 molding process, already the object of the patent filed in Italy for the same Applicant, No. 102017000019731 with title “Multi-step method for producing a soundproof composite cover for internal combustion engines and product thus obtained”. In particular:
A) injection step;
B) cooling step;
C) opening and transfer step;
D) closing and foaming step;
E) solidification step;
F) extraction step;

the molded product thus obtained is therefore constituted by said bottom 11 and said foam 12, and is characterized in that it is provided with at least one bent perimeter edge 11′ adapted to be irreversibly glued with said cover 13 of said seat 10. The addition of the previously-listed components is carried out between said opening and transfer step (C) and said closing and foaming step (D).

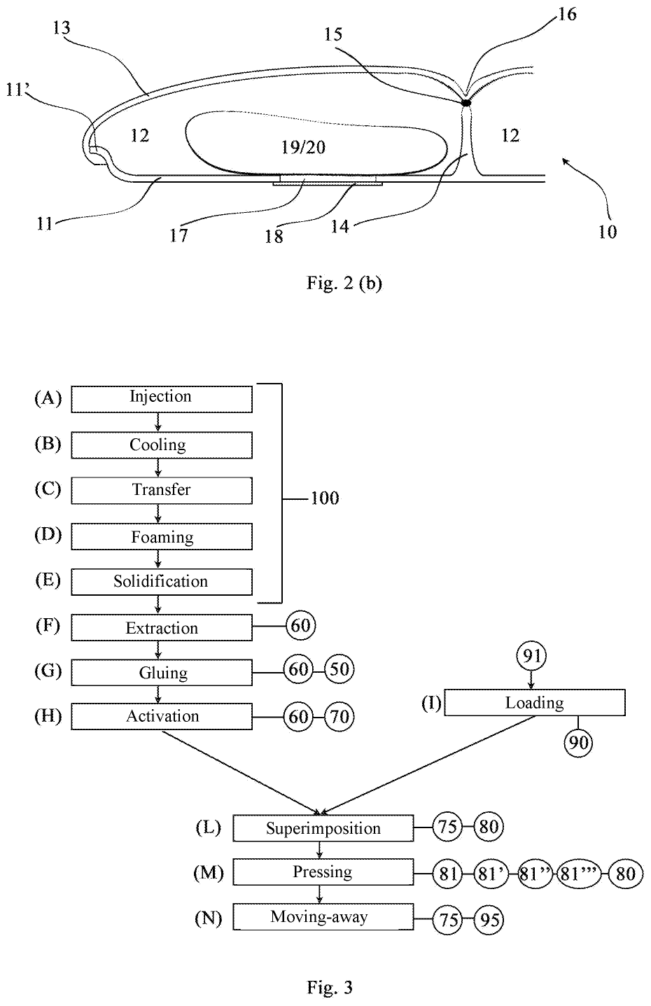

As represented in FIG. 2(a), moreover, the first cell 101 of the double mold 100 can be configured to ensure that the bottom 11 has one or more projections 14. These will be useful, in a subsequent assembly step, in order to be provided with a common retention system, preferably elastic, adapted to be irreversibly engaged with the cover 13 and form the abovementioned aesthetic recesses 16. The elasticity of the retention system 15 is especially preferably if the seat 10 is provided with reversibly inflatable air cushion 19, in order to allow the retention 15 to elastically accompany the increase of volume of the seat 10.

Once the molded product is attained, a first robot 60 provided with mechanical arm 61 is adapted to grasp the molded product from said double mold 100 in order to perform the following processing steps:
(G) gluing step: in said gluing step (G), said first robot 60 moves said solidified molded product to a nozzle 51 adapted to spray a predetermined quantity of a common glue coming from a tank 50. In particular, due to said gluing step (G), a uniform glue layer is spread over the entire surface of said bent perimeter edge 11′ of said bottom 11;
(H) activation step: in said activation step (H), said first robot 60 is adapted to transfer said molded product provided with glue into a heating station 70 constituted by a plurality of lamps 71-71′-71″ adapted to increase the temperature of said glue, bringing it to a value comprised between 50° C. and 100° C., preferably 70° C. in order to activate the adhesive properties thereof;
(I) loading step: said loading step (I) occurring simultaneously with said activation step
(H) and being carried out by a user 91 who arranges said cover 13 in a loading station 90;
(L) superimposition step: in said superimposition step (L), said loading station 90 automatically transfers said cover 13 into a superimposition station 80; simultaneously, a second robot 75, provided with a mechanical arm 76, is adapted to grasp said molded product from said heating station 70 and to transfer it into said superimposition station 80, positioning it on top of said cover 13 and with said foam 12 directed towards said cover 13;
(M) pressing step: said pressing step (M) occurs within said superimposition station 80 in which a plurality of grippers 81-81′-81″-81′″- . . . are adapted to press the edge of said cover 13 against said bent perimeter edge 11′ of said bottom 11 for a time period comprised between 40 sec and 100 sec, preferably 50 sec, determining the irreversible gluing between said bottom 11 and said cover 13, forming said seat 10. In a further embodiment of the present invention, said superimposition station 80 is provided with suitable connection means adapted to constrain said cover 13 to said bent perimeter edge 11′ of said bottom 11 also by means of sewing or ultrasound welding or any other mechanical connection system;
(N) moving-away step: in said moving-away step (N), said second robot 75 grasps said seat 10 from said superimposition station 80 and places it on a conveyor belt 95 adapted to move said seat 10, by now complete, away from the production area.

With reference to FIG. 2(b), one embodiment of the present seat 10 is shown in which the tank 19 and/or the inflatable cushion 20 are inserted within said seat 10 after said extraction step (F), due to the arrangement of a suitable space 17 obtained on the surface of said bottom 11 during the molding. The space 17 is subsequently closed by means of a common closure element 18 welded on said bottom 11, preferably by means of an ultrasound welding technique.

Finally, it is clear that modifications, additions or variations that are obvious for a man skilled in the art can be made to the invention described up to now, without departing from the protective scope that is provided by the enclosed claims.

1. Method for producing a seat (10) for a seating of any one road vehicle and product thus obtained, said seat (10) being constituted by a bottom (11) adapted to act as a lower structural support of said seat (10), a filler foam (12), of a thickness such to render said seat (10) soft and comfortable, and at least one cover layer (13) adapted to enclose and completely finish the upper face of said seat (10), said cover (13) being made of any one polymer material, wherein said bottom (11) is made of any one thermoplastic polymer, said bottom (11) and said foam (12) being obtained by means of a molding process by using a double mold (100); the latter being constituted by a first cell (101), provided with a male element (101.a) and a female element (101.b), and by at least one second cell (102), provided with a male element (102.a) and a female element (102.b), said first and said at least one second cell (101, 102) being adapted to assume, in a simultaneous and reversible manner, a first closed configuration in which said male elements (101.a, 102.a) and said female elements (101.b, 102.b) are partially in contact with each other, respectively by means of a first contact area (101.c) and a second contact area (102.c), in a manner so as to define, respectively, a first interspace (101.d) adapted to be filled with the thermoplastic polymer which will constitute said bottom (11) when cooled and at least one second interspace (102.d) adapted to contain the previously-described bottom (11) and said foam (12); said cells (101, 102) of said multiple mold (100) also being adapted to assume, in a simultaneous and reversible manner, a second open configuration in which said male elements (101.a, 102.a) and said female elements (101.b, 102.b) are spaced from each other in order to allow the extraction of the finished product; said molding of said bottom (11) together with said foam (12) occurring according to the following processing steps:
A) injection step: in said injection step (A), said multiple mold (100) is situated in said first closed configuration and, by means of a channel (110) placed at said female element (101.b) of said first cell (101), a predetermined quantity of said thermoplastic polymer at the liquid state adapted to constitute said bottom (11) is injected from a hot chamber (105) to said first interspace (101.d) of said first cell (101);
B) cooling step: in said cooling step (B), one awaits a predetermined time period, starting from the end of said injection step (A), in a manner so as to allow the lowering of the temperature of said thermoplastic polymer constituting said bottom (11) up to the complete solidification thereof;
C) opening and transfer step: in said opening and transfer step (C), said multiple mold (100) that is situated in said first closed configuration passes to said second open configuration in a manner so as to allow the extraction of said bottom (11) from said first cell (101) and hence the positioning thereof in said second interspace (102.d) of said second cell (102);
D) closing and foaming step: in said closing and foaming step (D), said multiple mold (100) is closed in a manner so as to once again assume said first closed configuration and, while a new injection process (A) occurs in said first cell (101), a predetermined quantity of foam (12) is injected into said second cell (102) in a manner so as to fill the interspace (102.d) present between said bottom (11) and said male element (102.a), in a manner such that, being solidified, said foam (12) irreversibly adheres to the bottom (11) with which it is directly in contact;
E) solidification step: in said solidification step (E), one awaits a predetermined time period, starting from the end of said foaming step (D), in a manner so as to allow the expansion, the stabilization and the adhesion of said foam (12) to said bottom (11);
F) extraction step: in said extraction step (F), said multiple mold (100) is opened in order to once again assume said second open configuration, and in said extraction step (F), the finished product is extracted from said second cell (102) and, simultaneously, the bottom (11) is extracted from said first cell (101) and placed in said second cell (102), giving rise to a new transfer step (C);
the molded product thus obtained, being solidified and being constituted by said bottom (11) and said foam (12), being provided with at least one bent perimeter edge (11′) adapted to be irreversibly glued with said cover (13) of said seat (10); said molded product, obtained by means of the aforesaid processing steps, being adapted to be picked up from said mold (100), during said extraction step (F), by a first robot (60) provided with a mechanical arm (61) adapted to grasp said solidified molded product in order to subject it said solidified molded product to the following processing steps:
(G) gluing step: in said gluing step (G), said first robot (60) being adapted to move said solidified molded product, constituted by said bottom (11) and said foam (12), to a nozzle (51) adapted to spray a predetermined quantity of a common glue coming from a tank (50) connected to said nozzle (51); said gluing step (G) causing the spreading of a uniform layer of glue over the entire surface of said bent perimeter edge (11′) of said bottom (11);
(H) activation step: in said activation step (H), said first robot (60) is adapted to transfer said molded product provided with glue on said bent perimeter edge (11′) into a heating station (70) constituted by a plurality of lamps (71-71′-71″) adapted to increase the temperature of said glue, bringing the glue to a value comprised between 50° C. and 100° C. in order to activate the adhesive properties thereof;
(I) loading step: said loading step (I) occurring simultaneously with said activation step (H) and being carried out by a user (91) who arranges said cover (13) in a loading station (90);
(L) superimposition step: in said superimposition step (L), said loading station (90) transfers said cover (13) into a superimposition station (80); simultaneously, a second robot (75), provided with a mechanical arm (76), is adapted to grasp said molded product from said heating station (70) and transfer said molded product into said superimposition station (80), positioning said molded product above said cover (13) and with said foam (12) directed towards said cover (13);
(M) pressing step: said pressing step (M) occurs within said superimposition station (80), in which a plurality of grippers (81-81′-81″-81′″- . . . ) are adapted to press the edge of said cover (13) against said bent perimeter edge (11′) of said bottom (11) for a time period comprised between 40 sec and 100 sec, causing the irreversible gluing between said bottom (11) and said cover (13), forming said seat (10);
(N) moving-away step: in said moving-away step (N), said second robot (75) being adapted to grasp said seat (10) from said superimposition station (80) and to bring said seat onto a conveyor belt (95) adapted to move said seat (10), by now complete, away from the production area.

2. Method for producing a seat (10) for a seating of any one road vehicle and product thus obtained, according to claim 1, wherein between said transfer step (C) and said foaming step (D), an air cushion (20) is arranged within the mold (100), such air cushion (20) reversibly inflatable and adapted to allow the height-wise adjustment of said seat (10); said cushion (20) being arranged within said mold (100) in a first inflated configuration so that said cushion (20) occupies a volume ranging from ½ to about ¼; said cushion (20) being susceptible of reversibly assuming a second deflated configuration, wherein said cushion (20) occupies a volume equal to about 1/10 of the volume of said foam (12).

3. Method for producing a seat (10) for a seating of any one road vehicle and product thus obtained, according to claim 1, wherein between said transfer step (C) and said foaming step (D), a system of air emission tubes is arranged within the mold (100), adapted to cool said seat (10); said cover (13) being micro-perforated in order to allow the outflow of air.

4. Method for producing a seat (10) for a seating of any one road vehicle and product thus obtained, according to claim 1, wherein between said transfer step (C) and said foaming step (D), a tank (19) of a common extinguishing liquid or foam is arranged within the mold (100).

5. Method for producing a seat (10) for a seating of any one road vehicle and product thus obtained, according to claim 1, wherein between said transfer step (C) and said foaming step (D), a system of heating elements is arranged within the mold (100), such heating elements adapted to allow the controlled heating of the seat (10).

6. Method for producing a seat (10) for a seating of any one road vehicle and product thus obtained, according to claim 4 claim 1 said tank (19) and/or said cushion (20) are inserted within said seat (10) after said step (F) of extraction of said molded product from said mold (100), due to the prearranging of a suitable space (17) obtained on the surface of said bottom (11);
said space (17) being closed, following the insertion of said tank (19) and/or of said cushion (20), by means of a common closure element (18) welded on said bottom (11).

7. Method for producing a seat (10) for a seating of any one road vehicle and product thus obtained, according to claim 1, wherein said superimposition station (80) is provided with suitable connection means adapted to constrain said cover (13) to said bent perimeter edge (11′) of said bottom (11), also by means of sewing or any other mechanical connection system during said pressing step (M).

8. Method for producing a seat (10) for a seating of any one road vehicle and product thus obtained, according to claim 1, wherein said superimposition station (80) is provided with suitable welding means adapted to constrain said cover (13) to said bent perimeter edge (11′) of said bottom (11), also by means of ultrasound welding during said pressing step (M).

9. Method for producing a seat (10) for a seating of any one road vehicle and product thus obtained, according to claim 1, wherein said bottom (11) is provided with a plurality of projections (14) obtained due to the configuration of said first cell (101) during said injection step (A); said projections (14) being adapted to be provided, during said transfer step (C), with a common retention mechanism (15) adapted to be stably and irreversibly engaged with said cover (13), creating aesthetic recesses (16) on the upper surface of said seat (10).

10. Method for producing a seat (10) for a seating of any one road vehicle and product thus obtained, according to claim 1 wherein in said injection step (A), metal plates for reinforcement or fixing are co-molded within the bottom (11).

11. Method for producing a seat (10) for a seating of any one road vehicle and product thus obtained, according to claim 1, wherein said seat (10) belongs to the rear seating of a vehicle.

12. The method of claim 1, wherein the bottom comprises a thermoplastic polymer.

13. The method of claim 1, wherein the bottom comprises polypropylene.

14. The method of claim 1, wherein the bottom comprises polypropylene with long glass fibers.

15. The method of claim 1, wherein in step (H), the glue is brought to a temperature of 70° C.

16. The method of claim 1, wherein in step (M), the plurality of grippers are adapted to press the edge of said cover against said bent perimeter edge of said bottom for 50 seconds.

17. The method of claim 2, wherein said cushion is arranged within said mold in a first inflated configuration so that said cushion occupies a volume of ⅓ of the overall volume of said foam (12).

18. The method of claim 6, wherein said common closure element is welded on said bottom by means of an ultrasound welding technique.

19. The method of claim 9, wherein said retention mechanism is elastic.

20. The method of claim 11, wherein the vehicle is a car.
